(19) United States
(12) Patent Application Publication
(10) Pub. No.: US 2020/0398482 A1
(43) Pub. Date: Dec. 24, 2020

(54) METHODS AND APPARATUS FOR THE MANUFACTURE OF THREE-DIMENSIONAL OBJECTS

(71) Applicant: Xaar 3D Limited, Cambridge Cambridgeshire (GB)

(72) Inventors: Frederik TJELLESEN, Cambridge Cambridgeshire (GB); Anders HARTMANN, Cambridge Cambridgeshire (GB); Torben LANGE, Cambridge Cambridgeshire (GB); Adam ELLIS, Cambridge Cambridgeshire (GB); Christopher NOBLE, Cambridge Cambridgeshire (GB); Michael CALEY, Cambridge Cambridgeshire (GB); Andrew MORSE, Cambridge Cambridgeshire (GB)

(21) Appl. No.: 16/765,030

(22) PCT Filed: Nov. 16, 2018
(86) PCT No.: PCT/GB2018/053338

§ 371 Date: May 18, 2020

(30) Foreign Application Priority Data
Nov. 17, 2017 (GB) 1719089.3

(51) Int. Cl. B29C 64/165; B29C 64/209; B29C 64/236; B29C 64/393; B29C 64/245; B29C 64/277; B29C 64/314

(52) U.S. Cl. CPC B29C 64/165; B29C 64/209; B29C 64/236; B33Y 10/00; B29C 64/245; B29C 64/277; B29C 64/314; B29C 64/393

(57) ABSTRACT

A method for the manufacture of three-dimensional objects is disclosed, utilising an independently operable printing sled (350) for sintering fusible powder and an independently operable powder distribution sled (300) for depositing a layer of fusible powder on the sintered layer. Since the printing sled and the powder distribution sled are independently operable, the time between sintering and deposition can be altered, dependent on the printing conditions and materials, resulting in an enhanced bond between the layers of the three-dimensional object.

### FIELD OF THE INVENTION

The present techniques relate to methods and apparatus for the manufacture of three-dimensional objects. More particularly, the techniques relate to methods for use in the apparatus for the manufacture of three-dimensional objects.

### BACKGROUND TO THE INVENTION

Apparatus for the manufacture of three-dimensional objects using laser sintering (LS) and high speed sintering (HSS) are known. Both LS and HSS apparatus deposit a layer of powdered material. LS apparatus uses a laser to trace the shape of a layer of the object in the powdered material, sintering the powdered material. Another layer of powdered material is then deposited and the shape of the next layer of the object is traced by the laser, and so on, to fabricate a three-dimensional object. However, LS takes a relatively long time, since the laser is required to trace the shape of the object when each new layer of powder is added.

In contrast to LS where the laser is required to trace the shape of the object in each layer of powdered material, a high speed sintering (HSS) process may be used. In HSS, a radiation absorbing material (RAM) is printed in the shape of each layer of the object onto the layer of powder, typically in one pass of a printhead or row of printheads. Then each printed layer is irradiated with a radiation source, for example, an infrared light, across the entire build area, such that only the powder to which the RAM has been applied is fused. This substantially reduces the build time.

### SUMMARY OF THE INVENTION

Aspects of the invention are set out in the appended independent claims, while details of particular embodiments are set out in the appended dependent claims.

### BRIEF DESCRIPTION OF THE DRAWINGS

Embodiments will now be described with reference to the accompanying Figures of which:

FIG. 1 schematically illustrates an apparatus for manufacture of three-dimensional objects;

FIG. 2 schematically illustrates a cut through of components of the apparatus;

FIG. 3 schematically illustrates another cut through of components of the apparatus;

FIG. 4 schematically illustrates another cut through of components of the apparatus;

FIG. 5 schematically illustrates an embodiment of an agitator;

FIG. 6A-D schematically illustrate arrangements of a powder distribution sled and a printing sled;

FIG. 7 illustrates a process flow of a method of operation of the apparatus for the manufacture of three dimensional objects;

FIG. 8 illustrates another process flow of a method of operation of the apparatus for the manufacture of three dimensional objects; and

FIG. 9 illustrates another process flow of a method of operation of the apparatus for the manufacture of three dimensional objects.

### DETAILED DESCRIPTION

The following disclosure describes a method for manufacturing a three-dimensional object from a powder. The method comprises printing an absorber onto a layer of powder deposited in a build area, by moving a printhead, provided on a print sled, in a first direction across the build area; sintering the layer of powder where the absorber has been printed, by moving a first radiation source in the first direction across the build area; and depositing another layer of the powder in the build area, by moving a distribution sled, in the first direction across the build area, the distribution sled being independently operable from the print sled.

The following disclosure additionally describes a method for manufacturing a three-dimensional object from a powder. The method comprises printing an absorber onto a layer of powder deposited in a build area, by moving a printhead, provided on a print sled, in a first direction across the build area;

sintering the layer of powder where the absorber has been printed, by moving a first radiation source in a second direction, opposite to the first direction back across the build area; and depositing another layer of the powder in the build area, by moving a distribution sled, in the second direction across the build area, the distribution sled being independently operable from the print sled.

The following disclosure additionally describes an apparatus for manufacturing a three-dimensional object from a powder using the methods described herein.

The following disclosure additionally describes a controller for an apparatus for manufacturing a three-dimensional object from a powder. The controller is configured to receive instructions from a data store to: control a print sled to move across a build area covered in a layer of powder; control one or more printheads to print an absorber onto the layer of powder while the print sled moves across the build area; control a radiation source to irradiate the layer of powder following printing of the absorber; control a deposition sled comprising a spreader device to move across the build area independently from the printing sled to deposit a new layer of powder over the build area, such that the deposition sled movement is initiated in response to temperature data from a sensor sensing a temperature of the sintered layer.

The following disclosure additionally describes a computer program or set of instruction code comprising instructions which, when executed by such a controller, cause the present apparatus to execute a method for manufacturing a three-dimensional object from a powder. Also provided is a computer-readable medium comprising such instructions.

Reference will now be made in detail to the embodiments, examples of which are illustrated in the accompanying drawings. In the following detailed description numerous specific details are set forth by way of examples in order to provide a thorough understanding of the relevant teachings. However, it will be apparent to one of ordinary skill in the art that the present teachings may be practiced without these specific details.

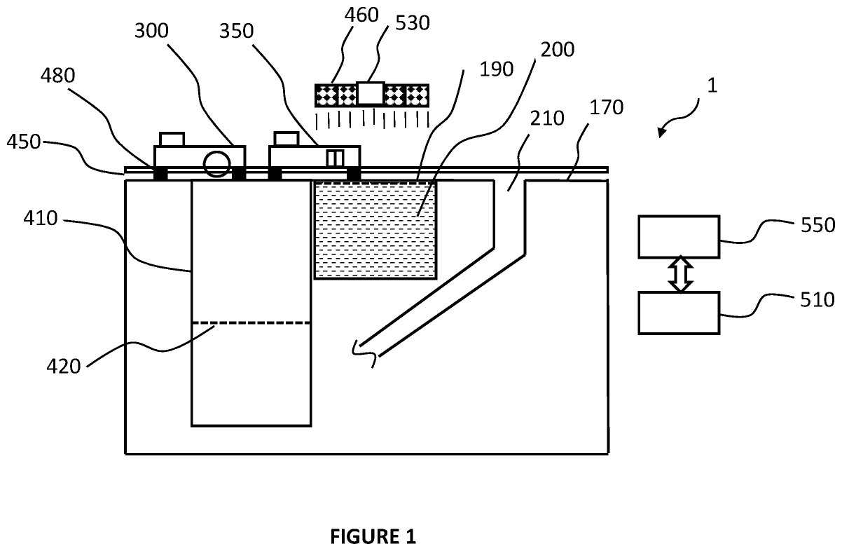

FIG. 1 schematically illustrates an apparatus 1 for the manufacture of three-dimensional objects, which uses high speed sintering (HSS). The apparatus 1 fabricates three-dimensional objects from a build powder. The build powder may be, or may comprise, a thermoplastic polymeric material such as PA11, PA12, PA6, polypropylene (PP), polyurethane or other polymers. Some metals or ceramics may also be compatible with the apparatus dependent on the sintering temperature achievable by the radiation source of the apparatus, and whether the metal or ceramic powder does not absorb certain wavelengths.

The apparatus 1 comprises a holding tank 410 for storing the build powder. The build powder is deposited in the holding tank 410 as required. According to one embodiment, fresh “virgin” powder is deposited in the holding tank 410. Fresh powder is considered to be powder which has not be used in the apparatus 1 previously. As discussed in more detail later, according to another embodiment, excess powder which is not sintered during a cycle of the apparatus 1 may be returned to the holding tank 410 and blended with the virgin powder. A cycle of the apparatus 1 is considered to begin when a layer of powdered material is deposited in a build area. A radiation absorbing material (RAM) is then printed on the layer of powdered material and the entire build area is exposed to a radiation source to sinter the powder. Following sintering, the build area is lowered, this is considered to be the end of the cycle. When another layer of the powdered material is deposited in the build area, a next cycle of the apparatus is considered to have begun.

The apparatus 1 also comprises a powder distribution sled 300 and a printing sled 350 arranged on bearings 480 on rails 450. The rails 450 suspend the sleds 300, 350 above a work surface 170 of the apparatus 1. The work surface 170 comprises a build area 190 provided at the top of a build chamber 200. An overhead heater 460, such as a ceramic lamp, may be provided above the build area 190, and a return slot 210 may be provided to one side of the build area 190, for example as illustrated in FIG. 1.

As known in the art, build powder may become compacted and consequently inhibits flow of the powder from the holding tank 410. In order to prevent this, the holding tank 410 may be provided with a stirring device 420 to keep the powder flowing freely. According to one embodiment, the powder may be continuously stirred, following introduction to the holding tank 410. According to another embodiment, the powder may be periodically stirred, following introduction to the holding tank 410.

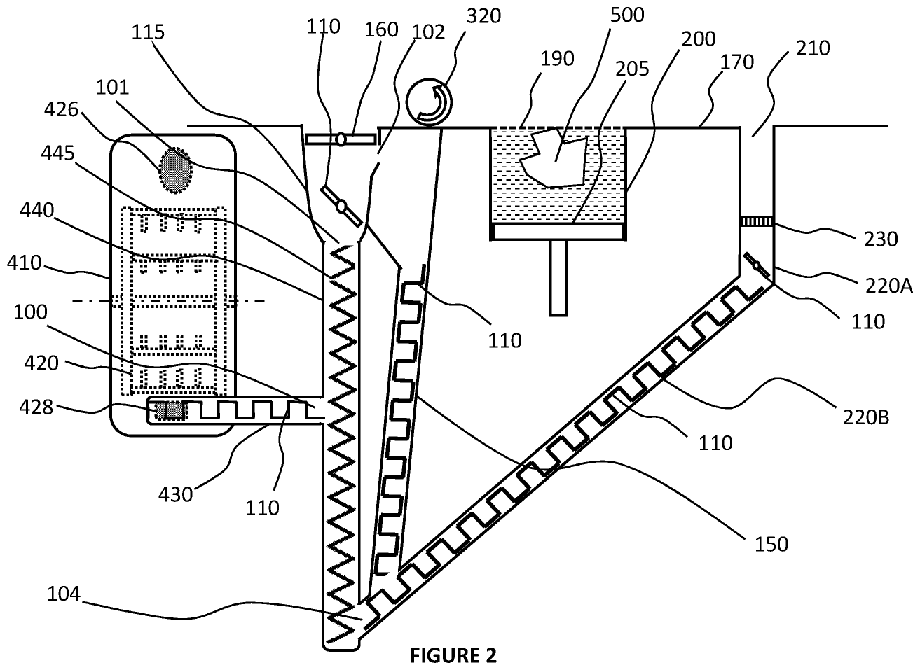

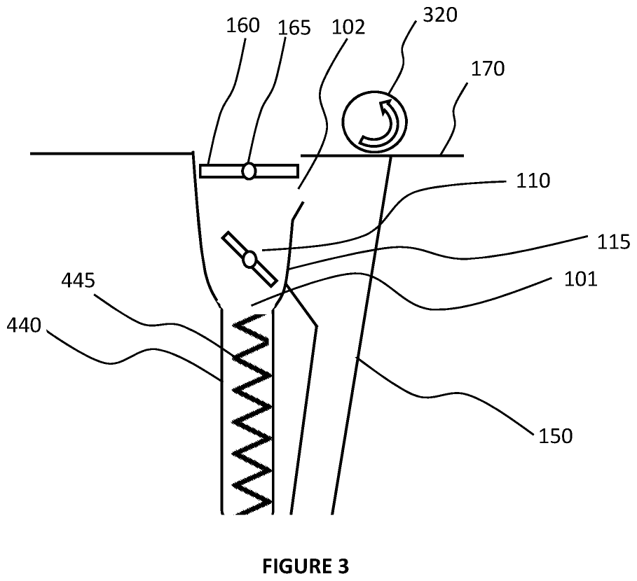

FIG. 2 schematically illustrates a cut through of the components of the apparatus 1. The powder enters the holding tank 410 through inlet 426 and exits the holding tank 410 through outlet 428. Upon exit from the holding tank 410, via the outlet 428, the powder travels into a supply tube 430. The outlet 428 may be located at the bottom of the holding tank 410, or may be located on a wall of the holding tank 410. FIG. 3 illustrate the outlet 428 being located on a wall of the holding tank 410, above the floor of the holding tank 410. For this location, it may be necessary to use stirring device 420 within the tank 410 to ensure that the powder below the outlet 428 is being used.

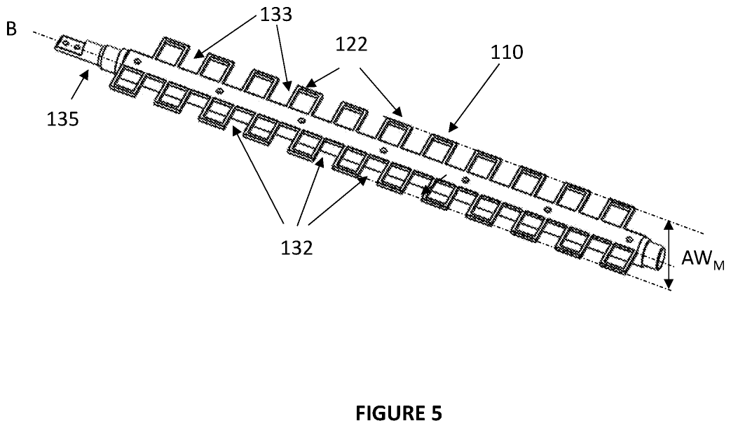

The powder flows through the outlet 428 into the supply tube 430. The supply tube 430 may comprise an agitator arranged within the supply tube 430, which aids the free flow of the powder, by gravitational force alone, along the supply tube 430 to a delivery tube 440. The agitator is described in more detail below with reference to FIG. 5. The powder then enters the delivery tube 440 at inlet 100.

The delivery tube 440 comprises a delivery mechanism arranged within the delivery tube 440, which aids movement of the powder along the delivery tube 440 to an inlet 101 to a powder repository 115. According to one embodiment, the delivery mechanism comprises an auger screw 445 provided within the delivery tube 440, extending at least within the majority of the delivery tubes 440 length. The auger screw diameter is slightly smaller than the inner diameter of the delivery tube 440, such that the auger screw 445 is capable of rotation within the delivery tube 440. As known in the art, an auger screw 445 comprises a helical blade, which, when rotated within the delivery tube 440, conveys the powder along the direction of the axis of rotation. The auger screw 445 may be arranged to convey the powder from the inlet 100 along the delivery tube 440 towards the inlet 101 to the powder repository 115 by imparting on the powder a force along the axis of rotation. According to one embodiment, the delivery tube 440 may be arranged at an angle to the vertical direction, such that the delivery tube 440 is angled upwards with respect to the gravitational direction.

According to one embodiment, as illustrated in FIG. 3, the supply tube 430 is connected to the delivery tube 440 at inlet 100, located part way along the length of the delivery tube 440 and the auger screw 445. For example, the supply tube 430 may be connected to the delivery tube 440 a location closer to a downstream end, with respect to the direction of powder delivery. The above described arrangement of the holding tank 410, supply tube 430 and delivery tube 440 enables the holding tank 410 to be contained below a work table level (work surface 170) of the apparatus 1, minimising the vertical height that the powder needs to be conveyed to reach the work surface 170, and providing space below the connection point 100 of the supply tube 430 to the delivery tube 440 where other tubes may be connected to the delivery tube 440.

When the holding tank 410 is unheated, the supply tube 430 may be thermally decoupled from the delivery tube 440 via insulation between the supply tube 430 and the delivery tube 440.

As illustrated in FIG. 3, the delivery tube 440 is connected to a substantially horizontal powder repository 115 at inlet 101, which may for example take the overall shape of an elongate slot. The auger screw 445 conveys the powder along the delivery tube 440 into the repository 115 via inlet 101. The inlet 101 acts as a feed point, feeding the powder into the repository 115. Although FIG. 3 illustrates the delivery tube 440 connecting to one end of the repository 115, the delivery tube 440 may be connected at any location along the repository 115, such as, at or near one end of the repository 115, or about halfway along the length of the repository 115. According to another embodiment, there may be provided more than one delivery tube 440 and inlet 101, such that the powder is conveyed into the repository 115 from multiple inlets 101.

An agitator 110 may be provided within the powder repository 115. Movement of the agitator 110 within the powder repository 115 keeps the powder in a free flowing or near free flowing state, such that it prevents the powder from agglomerating and allows it to spread along the length of the agitator by gravitational force. FIG. 5 illustrates an exemplary agitator 110. The agitator 110 may span the length of the powder repository 115 and be sized such as to be able to rotate within the repository 115 without touching the walls of the repository 115.

As illustrated in FIGS. 2 to 4, the repository 115 comprises an outlet 102 such that when the powder reaches a certain level within the repository 115, the powder flows through the outlet 102 and is reintroduced into the delivery tube 440. Consequently, any unused powder is recirculated into the delivery tube 440. The powder from outlet 102 travels along a recirculating tube 150. The recirculating tube 150 may be arranged such that the powder enters and travels along it by gravitational force.

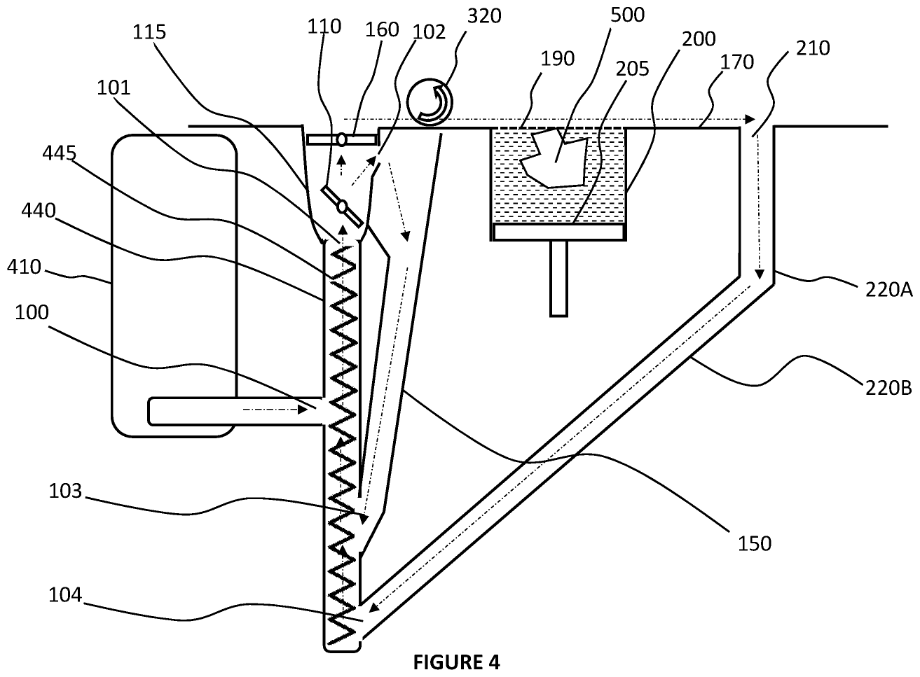

According to the embodiment illustrated in FIG. 4, the recirculating tube 150 may be connected to the delivery tube 440 at a point upstream of the supply tube 430, such that the recirculated, unused but heated, powder enters the delivery tube 440 at inlet 103 and is conveyed along the delivery tube 440 by the auger screw 445. Virgin powder from the supply tube 430 may be mixed with the recirculated powder in the delivery tube 440 when the auger screw 445 has capacity to receive more powder from the supply tube 430.

According to one embodiment, as illustrated in FIG. 2, the recirculating tube 150 may comprise an agitator 110, for example as described above with reference to FIG. 5, arranged over part or all of the length of the recirculating tube 150 to ensure free flow of the powder along the recirculating tube 150 aided by gravity.

Returning now to FIGS. 2 to 4, the delivery of powder onto the work surface 170 will be described. The apparatus comprises a dosing blade 160 provided at or near the top of the repository 115. The dosing blade 160 is capable of rotation about the axis of rotation C, which is the axis extending along the length direction of the repository 115 and through the centrally protruding pivot shaft 165. The dosing blade 160 is provided above the agitator 110.

When the dosing blade 160 is rotated through 180 degrees, it pushes powder which has accumulated near the top of the repository 115 onto the work surface 170 to form a pile of powder on the work surface 170, along the length of the top surface of the repository 115.

The powder is then spread across the work surface 170 by a roller 320, which is arranged on a powder distribution sled 300 discussed in further detail below. The roller 320 pushes the powder across the work surface 170, covering the build area 190 in a thin layer of powder. The thickness of the layer of powder is determined by the distance the floor 205 of the build chamber 200 has been lowered relative to the top surface of the previous layer of powder.

The three-dimensional object 500 to be manufactured is formed within the build area 190 of the build chamber 200. A thin layer of powder is spread across the floor 205 of the build chamber 200. The powder is printed onto and sintered, as discussed in detail below, after which the floor 205 of the build chamber 200 is lowered within the build chamber 200, and the next layer of powder is spread onto the printed powder bed. The layers of powder are built up by successive spreading/printing/sintering steps as for each step the floor 205 of the build chamber 200 is lowered within the build chamber 200 by the thickness of a layer of each step.

Any excess powder at the end of travel of the roller 320 which has not been used in covering the build area 190 may be recovered for further use. FIGS. 2 and 4 illustrates a return slot 210 provided to the work surface 170 at a side of the build area 190 opposite from the dosing blade 160. The return slot 210 may be arranged to receive excess powder which is pushed into the return slot 210 by the roller 320. According to one embodiment, a filter or mesh may be provided in the return slot 210 to prevent unwanted objects from entering the apparatus 1. Examples of unwanted objects are large agglomerations, broken of parts from sintered/printed models or similar unwanted objects.

The apparatus 1 does not measure the amount of powder to be deposited by the dosing blade on the work surface in order to deposit a layer of powder in the build area 190. Instead, the dosing blade provides approximately the same amount for each layer deposition step, which is more powder than is required for a new powder layer, and the excess powder which is not required is pushed into the return slot 210. By providing too much powder at the work surface, an even distribution of the powder across the build area may be achieved.

The return slot 210 is coupled to a return tube 220. The return tube 220 may comprise two tubes, namely, an upper return tube 220A and a lower return tube 220B. The return slot 210 may contain an agitator 110 so as to maintain the powder in a free flowing state. The excess powder travels along the return tube 220. The return tube 220 may be arranged such that the excess powder travels along it by gravitational force.

The return tube 220 (the lower return tube 220B) may be connected to the delivery tube 440, as illustrated in FIG. 4, at a point upstream of the supply tube 430, such that the excess powder enters the delivery tube 440 at inlet 104 and is conveyed along the delivery tube 440 by the auger screw 445. Virgin powder from the supply tube 430 may be mixed with the excess powder in the delivery tube 440 when the auger screw 445 has capacity to receive more powder from the supply tube 430. The excess powder travels back to the repository 115 once again. Accordingly, unused excess powder is recirculated via the return tube 220 into the delivery tube 440. According to one embodiment, an agitator 110 may be provided in all or part of the length of the return tube 220, to ensure the free flow of powder along the tube 220.

As illustrated in FIG. 2, the return tube 220 may be connected to the recirculating tube 150, such that the excess powder and recirculated powder are combined and enter the delivery tube 440 at the same inlet. It may be beneficial to connect the return tube 220 and the recirculating tube 150 so as to minimise the entry points into the delivery tube 440. Additionally, by combining the excess powder and the recirculated powder prior to entry to the delivery tube 440, the excess powder and the recirculated powder are given the same priority of being reintroduced into the delivery tube 440.

Alternatively, the return tube 220 may be connected to the delivery tube 440 at an inlet 104 upstream of the inlet 100 from the supply tube 430, and, for example, also upstream of the inlet 103 of the recirculating tube 150. This prioritises the use of powder from the return tube 220 over that of the recirculating tube 150, and prioritises the use of powder from the recirculating tube 150. This arrangement is illustrated in FIG. 4.

It will be appreciated that the references to the supply tube 430, recirculating tube 150 and return tube 220 are not limited to having a cylindrical cross section. Instead, the tubes may have any suitable cross section, for example that of a semicircle, oblong, or rectangular cross section etc. Furthermore, the powder repository 115, supply tube 430, recirculating tube 150 and return tube 220 may all be considered flow paths for the powder. Moreover, the powder repository 115, the supply tube 430, the recirculating tube 150 and/or the return tube 220 may comprise an agitator so as to maintain the powder in a free flowing state whilst travelling along these powder flow paths.

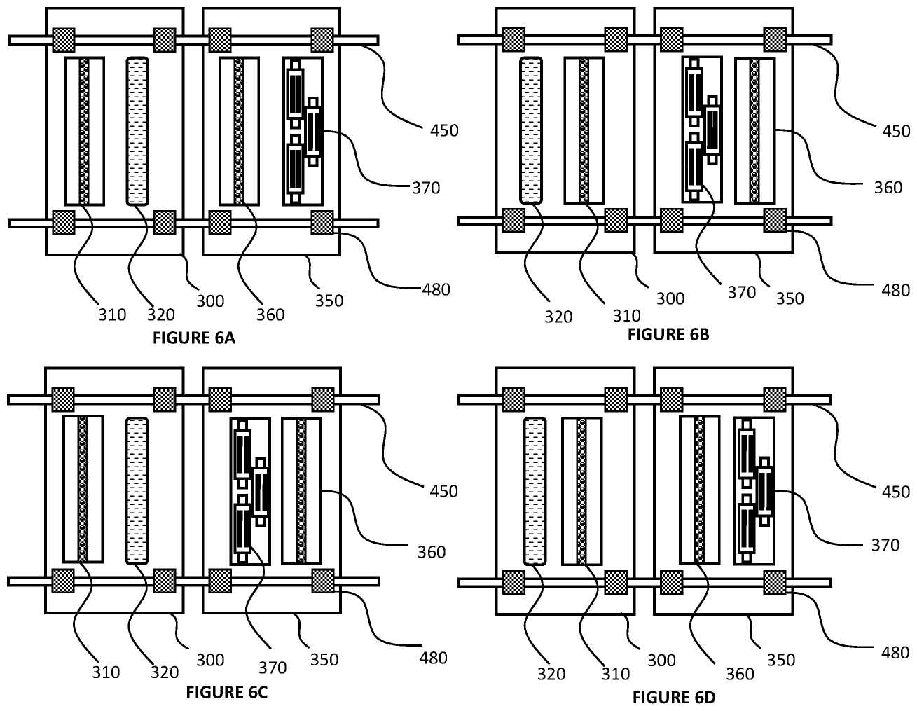

Turning now to the operation of the powder distribution sled 300 and the printing sled 350, FIG. 1 illustrates two independently operable sleds 300, 350 provided above the work surface 170 of the apparatus 1. FIGS. 6A to 6D illustrate four different layouts of the powder distribution sled 300 comprising a pre-heat source 310 and a roller 320, and of the printing sled 350 comprising a sinter source 360, such as an infrared radiation lamp, and printheads 370. According to another embodiment, the powder distribution sled 300 may not comprise the pre-heat source 310. Instead, or additionally, an overhead radiation source may be provided above the build area 190 in order to pre-heat the powder.

The four different layouts of the powder distribution sled 300 and the printing sled 350 illustrated in FIG. 6A-6D will now be described with respect to an arrangement direction from the repository on one side of the build area, to the return slot on the opposite side of the build area, such as illustrated in FIG. 1:

FIG. 6A illustrates in the arrangement direction of FIG. 1, the powder distribution sled 300 having a preheat source 310 followed by a roller 320; followed by the printing sled 350 having a sinter source 360 followed by one or more printheads 370.

FIG. 6B illustrates, in the arrangement direction of FIG. 1, the powder distribution sled 300 having a roller 320 followed by a preheat source 310; followed by the printing sled 350 having one or more printheads 370 followed by a sinter source 360.

FIG. 6C illustrates, in the arrangement direction of FIG. 1, the powder distribution sled 300 having a preheat source 310 followed by a roller 320; followed by the printing sled 350 having one or more printheads 370 followed by a sinter source 360.

FIG. 6D illustrates, in the arrangement direction, the powder distribution sled 300 having a roller 320 followed by a preheat source 310; followed by the printing sled 350 having a sinter source 360 followed by one or more printheads 370.

As will be described below, each of the arrangements of the sleds illustrated in FIGS. 6A to 6D necessitates a different order in the manufacturing steps, and each arrangement has its own advantages.

The pre-heat source 310 and the sinter source 360 are infrared radiation sources that may comprise halogen lamps, either in the form of modular sources or a full width single bulb; arrays of infrared radiation (IR) light-emitting diodes (LEDs); ceramic lamps; argon lamps; or any other suitable infrared radiation emitter.

The one or more printheads 370 for depositing the RAM may be standard drop on demand printheads suitable for use in an HSS apparatus, such as a Xaar 1003 printhead. The Xaar 1003 printhead for example is able to deposit RAM suspended or soluble in a variety of liquids, and tolerates well the challenging hot and particulate environment of an HSS printer due to its highly effective ink recirculation technology.

Returning to FIG. 1, the sleds 300, 350 may be moved across the work surface of the apparatus 1 via motors provided on each sled 300, 350 which may utilise the same drive belt or different drive belts, although other methods of moving the sleds may be utilised, as known in the art. According to one embodiment, the two sleds 300, 350 are moveable on the same set of rails. According to another embodiment, the two sleds 300, 350 are moveable on separate rails. Generally, to allow a compact apparatus, the sets of rails are arranged parallel to one another.

Following rotation of the dosing blade 160 to deposit a pile of powder on the work surface 170, the powder distribution sled 300 is moved across the work surface 170 of the apparatus. The roller 320 pushes the powder across the work surface 170, such that a layer of powder is spread across and covers the build area 190, and any excess powder is pushed down the return slot 210. When the powder distribution sled 300 also comprises a pre-heat source 310, the layer of powder may be heated by the preheat lamp 310 as it is spread across the build area 190 by the roller 320. However, when the powder distribution sled 300 does not comprise a pre-heat source 310, an overhead heat source may be provided above the build area 190.

The printing sled 350 is then moved across the work surface 170 of the apparatus, and an absorber, such as a radiation absorbent material (RAM), is printed onto the layer of powder within the build area 190 in accordance with image data defining the pattern of each layer of the final object being built, by the printheads 370. The printed portion of the layer of powder in the build area 190 is then sintered as the sinter lamp 360 is moved across the entire build area 190, with the effect that only the powder that received the absorber heats up sufficiently to fuse.

The floor 205 of the build chamber 200 is lowered within the build chamber 200, and the next layer of powder is spread across the work surface 170 by the roller 320, and the process begins again.

The build chamber floor 205 is lowered by the thickness of a layer of the build, this might be in the region of 0.1 mm.

In order to provide ease of access to the build area 190, the rails 450 may be offset from one another vertically. For example, the rail at the front of the machine may be below the level of the work surface 170 to allow easy access to the build chamber 200 whilst the back rail may be above the height of the work surface 170 to allow access for maintaining or cleaning the rail.

The position of the sleds 300, 350 relative to the build area 190 may be monitored by a position sensor provided on each sled 300, 350. The position sensors may be magnetic sensors with scale mounted on a static part of the machine, a rotary encoder, an optical sensor with scale mounted on a static part of the machine, laser positioning, etc.

According to one embodiment, where two successive print passes are possible as a result of the particular sequence, the first print pass may deposit 50% of the pattern to be printed, for example by only printing part the required density for each nozzle. Before the second pass, a portion of the printing sled 350 on which the printheads 370 are mounted may be moved in a direction perpendicular to the direction of movement of the sleds along the rails along a plane parallel to that of the build area. During the second pass, the remaining print density is printed in respective areas but by a different nozzle in the same location. Such a two pass print process allows to balance out non uniformities in nozzle performance and provides for a higher quality sintered object.

In order to achieve this perpendicular movement, the portion of the printing sled 350 may be moved, for example, by a motor and a cam that pushes against an upright section on the sled 300. It may also be advantageous to move the printheads 370 in a perpendicular direction for example when a nozzle of the printhead 370 is non-operational, so that a defective nozzle is shifted across the direction of printing between printing different layers of a three-dimensional object. This prevents a defective nozzle from creating a continuous dislocation through the entire finished printed three-dimensional object. The perpendicular movement of the printheads 370 may only range over a few millimetres, or over a few nozzle separations. It will be clear that such movement is not required to be perpendicular, but can be along another direction in the plane parallel to that of the build surface and crossing the direction of printing.

As is known in the art, high speed sintering machines operate at high temperatures, in particular in the proximity of the build area 190. For example, the temperature near the build area may be around 185° C. Consequently, temperature sensitive elements of the machine, such as printheads 370, may require to be shielded from the heat. An insulated housing may be provided around the printheads to provide such shielding.

An overhead heater 460 may be provided above the build area to provide a uniform temperature on the surface of the build area 190. The overhead heater 460 may be a fixed infrared radiation source, such as ceramic IR lamps or any other suitable radiation source.

A thermal feedback may be provided in order to control the temperature of the build area 190. For example, the temperature of the surface of the build area 190 may be measured with a temperature sensor such as an IR camera. Furthermore, the temperature of the build area 190 may be adjusted by changing one or more of the following, or a combination thereof:
heating the build chamber walls and/or floor: by heating the floor 205 and the walls of the build chamber, for example by heat foils, the temperature of the build floor 205 is elevated before powder deposition and thereby the difference to the required fusing temperature is reduced;
heating the build powder in the holding tank: by controlling the temperature of the supplied powder, the temperature rise to the required fusing temperature is reduced;
changing the speed of the sleds 300, 350: when the powder distribution sled 300 and/or the printing sled 350 move faster, the build area 190 is exposed to the pre-heat source 310 and/or the sinter source 360 for a shorter period of time, thus reducing the temperature of the build. Conversely, when the powder distribution sled 300 and/or the printing sled 350 move slower, the build area 190 is exposed to the pre-heat source 310 and/or the sinter source 360 for a longer period of time, thus increasing the temperature of the build;
changing the radiation intensity of the heat source(s): when the intensity of the pre-heat source 310 and/or the sinter source 360 is lowered, the temperature of the build area is reduced; conversely, when the intensity of the pre-heat source 310 and/or the sinter source 360 is increased, the temperature of the build area is increased;
changing the radiation wavelength of the sinter source 360: when the wavelength of the sinter source 360 is closest to the peak absorption of the radiation absorbent material printed by the printheads 370, a faster increase in temperature results; conversely, when the wavelength of the sinter source 360 is further away from the peak absorption of the radiation absorbent material printed by the printheads 370, a slower increase in temperature results.

According to one embodiment, bearings may be provided on one side of each sled 300, 350, the bearings being moveable orthogonal to the direction of movement of the sleds 300, 350 to allow the sleds 300, 350 to expand or contract with changes in temperature.

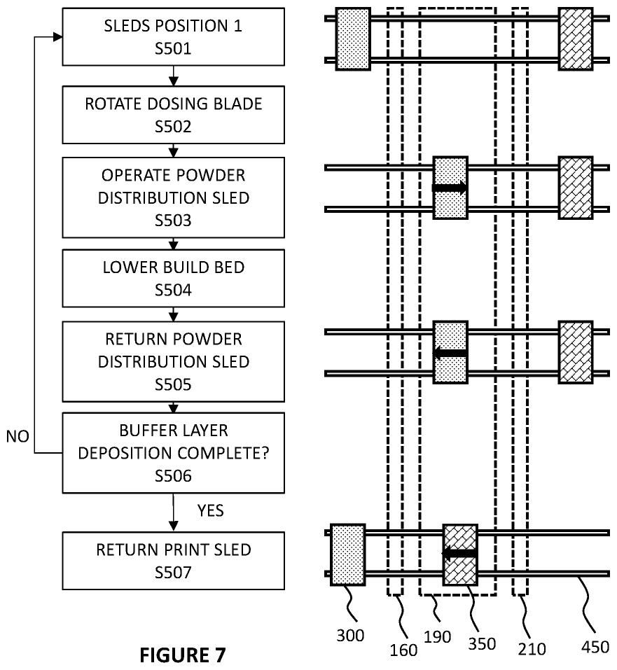

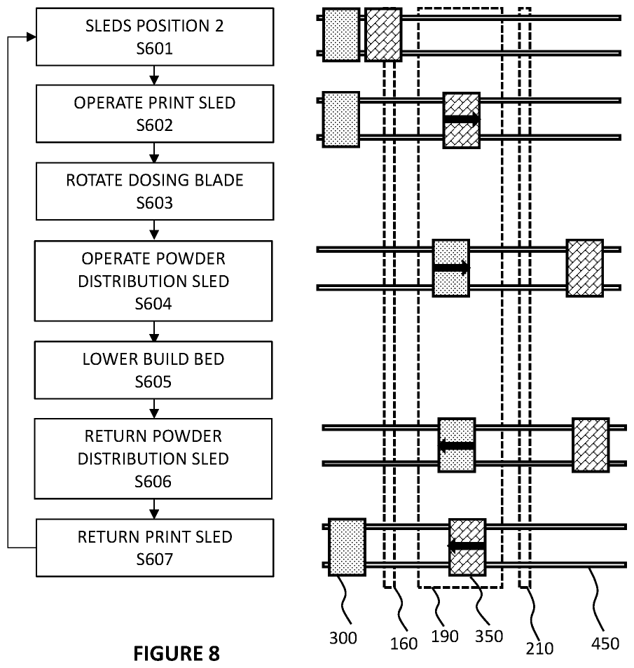

FIGS. 7 and 8 illustrate a method of operation for the apparatus 1 for the manufacture of three dimensional objects. It is known that to achieve an even build area temperature it is beneficial to deposit several buffer layers of powder on the build chamber floor, prior to commencing the build, to help mitigate the effects of unevenness in temperature distribution across the surface of the build area 190. This may be done in addition to the base of the build chamber floor 205 being heated. FIG. 7 illustrates a sequence of preparation steps used to deposit a number of buffer layers of powder, together with the position of each sled at each step.

At the start of the sequence, at step S501, the sleds 300, 350 are at sleds position 1, where the powder distribution sled 300 is arranged behind the dosing blade 160, such that the dosing blade is positioned between the powder distribution sled 300 and the build area 190, and the printing sled 350 is arranged at a side of the build area 190 opposite from that of the powder distribution sled 300, such that the return slot 210 is positioned between the printing sled 350 and the build area 190.

At step S502 the dosing blade 160 is rotated to bring up fresh powder along its length from the powder repository 115 to the work surface 170. At step S503, the powder distribution sled 300 is operated and travels across the dosing blade 160, pushing the powder across the build area 190 and then pushing any excess powder down the return slot 210. Next, in step S504, the floor 205 of the build chamber is lowered by a predetermined amount. At step S505, the powder distribution sled is returned to sleds position 1. The preheat lamp may be in operation whilst the sled travels over the build area 190 in either direction to preheat the powder.

This process may be repeated from S501 to S505 until the required number of buffer layers is deposited. The number of buffer layers may be monitored by a step S506. When the required number of buffer layers has not been deposited, then the process from steps S501 to S505 is repeated. Once the required number of buffer layers has been deposited and after S505, a step S507 may be initiated which returns the print sled 350 to the dosing blade side of the build area.

The buffer layers may or may not have the same thickness as the layers of a build. When the buffer layers are not the same thickness as the layers of a build, then one or more of the final buffer layers may be laid down at a thickness of the layers of a build to provide a first layer of the build. For example, a thickness of the build layers of a build may be 0.1 mm. This thickness may be achieved by lowering the floor 205 of the build chamber at step S504 by 0.1 mm.

According to one embodiment, the floor 205 of the build chamber may be lowered at step S504 by 0.5 mm to provide extra clearance, and then raised by 0.4 mm, after the powder distribution sled 300 has returned to sleds position 1, to achieve the layer thickness of 0.1 mm.

As an alternative to the process illustrated in FIG. 7, used to deposit a number of buffer layers of powder, it is possible to deposit a number of buffer layers of powder using the process illustrated in FIG. 8, as described below, but not printing from the printheads 370. The advantage of this process is that the energy supplied from the sleds 300, 350 is the same for both the buffer layers and the printed layers. When the buffer layers are deposited using the process illustrated in FIG. 8, the sinter source 360 irradiates the powder, but there is no sintering since a RAM has not been printed.

The operation of laying down buffer layers is similar for each of the four sled layouts illustrated in FIGS. 6A to 6D. However, as previously described, the four different sled layouts require different process steps during printing and sintering. These will now be described in relation to the high level process steps set out in FIG. 8.

A process for printing and sintering utilising the sled layout as illustrated in FIG. 6A will now be described, with reference to FIG. 8.

The sleds 300, 350 start at sleds position 2 at step S601, with both the powder distribution sled 300 and the printing sled 350 arranged behind the dosing blade 160, such that the dosing blade is positioned between the sleds 300,350 and the build area 190. The buffer layers have been deposited, and a first build layer of powder has been deposited as the final layer in the buffer layer process.

At step S602, the printing sled 350 is operated. The printing sled 350 moves across the build area 190 from the dosing blade side of the build area to the opposite side of the build area, the printing sled forward stroke. As the printing sled 350 moves across the build area 190, the printheads 370 print absorber in accordance with image data onto the layer of powder deposited in the build area 190. At the same time, the sinter source 360 which is mounted behind the printheads 370 on the printing sled 350 (with respect to the direction of travel during step S602) sinters the printed areas. Once the printing sled 350 is clear of the dosing blade 160 during step S602, or, if preferred, after the printing sled 350 has arrived at the opposite end of the work surface, at step S603 the dosing blade 160 is rotated, and a fresh pile of powder is brought up to the work surface level 170 along the full length of the dosing blade ready for distribution.

Next, at step S604 the powder distribution sled 300 is operated. The powder distribution sled 300 moves across the build area 190 from the dosing blade side of the work surface to the opposite side of the build area, the powder distribution sled forward stroke. The powder distribution sled 300 passes over the dosing blade 160, and the roller 320 pushes the pile of powder across the work surface 170, depositing a layer of powder in the build area 190, before pushing any excess powder down the return slot 210. The preheat source 310 which is mounted behind the roller 320 on the powder distribution sled 300 (with respect to the direction of travel during step S604) optionally preheats the freshly laid layer of powder.

At step S605, the build chamber floor 205 is lowered by the thickness of a layer of the build. At step S606, the powder distribution sled 300 is returned to the dosing blade side of the work surface, the powder distribution sled return stroke. After that and before RAM is printed onto the fresh powder layer, the build chamber floor is raised. It may be raised to a level just short by the next layer thickness to be deposited with respect to the powder surface.

The preheat source 310 may optionally be utilised to help maintain the surface of the build area at a predetermined temperature. Finally, at step S607, the printing sled 350 is returned to the dosing blade side of the work surface, the printing sled return stroke. Optionally, during the printing sled return stroke, the sinter source 360 may be used as a preheating source to help maintain the surface of the build area at a predetermined temperature.

The intensity and/or the wavelength of the radiation emitted by the sinter source 360 may be adjustable for this function. Optionally, absorber may be printed on the return stroke of the printing sled 350, as the printing sled 350 moves across the build area 190. This would allow two layers of absorber to be printed on each layer of powder, which is advantageous when there are defective or non uniform nozzles of the printhead. The nozzles of the printhead may be shifted in a transverse direction from the printing direction and another layer of absorber printed to avoid dislocations through a finished part, both layers of absorber combining to the total required for the powder layer as described above.

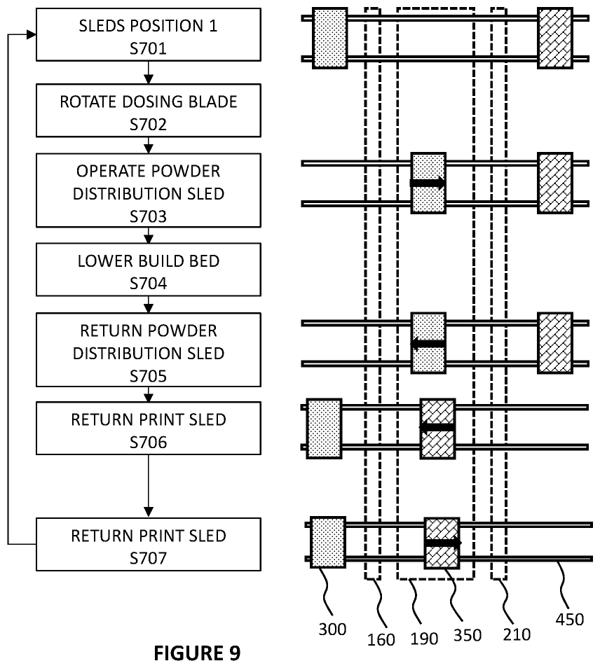

A process for printing and sintering utilising the sled layout as illustrated in FIG. 6B will now be described, with reference to FIG. 9.

The sleds 300, 350 start at sleds position 1 at step S701, where the powder distribution sled 300 is arranged behind the dosing blade 160, such that the dosing blade is positioned between the powder distribution sled 300 and the build area 190, and the printing sled 350 is arranged at a side of the build area 190 opposite from that of the powder distribution sled 300, such that the return slot 210 is positioned between the printing sled 350 and the build area i.e. the two sleds start at opposite ends of the build area 190. This is achieved by not carrying out step S507 at the end of laying the buffer layers (i.e. the printing sled 350 is not returned to the dosing blade side). In the arrangement of FIG. 6B, the radiation sources 310, 360 provided on the two sleds 300, 350 are arranged in front of the roller 320/printheads 370 respectively, in a direction from the dosing blade side to the return slot side.

At step S702 the dosing blade 160 is rotated, and a fresh pile of powder is brought up to the work surface level 170, along the full length of the dosing blade ready for distribution.

Next, at S703 the powder distribution sled 300 is operated. The powder distribution sled 300 moves across the build area 190 from the dosing blade side of the work surface across the build area 190 to the opposite side of the work surface, the powder distribution sled forward stroke. The powder distribution sled 300 passes over the dosing blade 160 and the roller 320 pushes the pile of powder across the work surface 170, depositing a thin layer of powder in the build area 190, before pushing the excess powder down the return slot 210. The preheat source 310 which is mounted in front of the roller 320 on the powder distribution sled 300 may not be switched on during this step.

At step S704, the build chamber floor 205 is lowered by the thickness of a layer of the build, this might be in the region of 0.1 mm.

Next, at step S705, the powder distribution sled 300 is returned to the dosing blade side of the work surface, the powder distribution sled return stroke. The preheat source 310 may optionally be switched on during the return of the powder distribution sled to preheat the fresh layer of powder. At step S706, the printing sled 350 is returned across the build area 190 to the dosing blade side of the work surface. During this printing sled 350 return stroke, as the printing sled 350 moves across the build area 190, the printheads 370 print absorber in accordance with image data onto the layer of powder deposited in the build area 190.

At the same time, the sinter source 360 which is mounted behind the printheads 370 on the printing sled 350 illustrated in FIG. 6B (with respect to the direction of travel during step S706) sinters the printed areas. The sleds are now in sleds position 2.

The printing sled 350 is next operated again at step S707 to return to the side of the build area opposite that of the dosing blade, the printing sled 350 forward stroke. Optionally, the sinter source 360 on the printing sled 350 may be switched on during step S707 to allow a second exposure of the printed powder to the sinter source which may cause the powder printed with RAM to reach a higher temperature.

A process for printing and sintering utilising the sled layout as illustrated in FIG. 6C, will now be described, with reference to FIG. 9.

The sleds 300, 350 start at sleds position 1 at step S701, where the powder distribution sled 300 is arranged behind the dosing blade 160, such that the dosing blade is positioned between the powder distribution sled 300 and the build area 190, and the printing sled 350 is arranged at a side of the build area 190 opposite from that of the powder distribution sled 300, such that the return slot 210 is positioned between the printing sled 350 and the build area i.e. the two sleds start at opposite ends of the build area 190. This is achieved by not completing step S507 at the end of laying the buffer layers (i.e. the printing sled 350 is not returned to the dosing blade side).

At step S702, the dosing blade 160 is rotated and a fresh pile of powder is brought up to the work surface level 170 along the full length of the dosing blade ready for distribution.

Next, at step S703 the powder distribution sled 300 is operated. The powder distribution sled 300 moves across the build area 190 from the dosing blade side of the work surface across the build area 190 to the opposite side of the work surface. The powder distribution sled 300 passes over the dosing blade 160 and the roller 320 pushes the pile of powder across the work surface 170, depositing a thin layer of powder in the build area 190, before pushing the excess powder down the return slot 210. The preheat source 310 which is mounted immediately behind the roller 320, in the direction of travel at step S703, on the powder deposition sled 300 may optionally preheat the freshly laid powder.

At step S704, the build chamber floor 205 is lowered by the thickness of a layer of the build, this might be in the region of 0.1 mm.

Next, at step S705, the powder distribution sled 300 returns to the dosing blade side of the work surface. Preheat source 310 may optionally be switched on during the return of the powder distribution sled 300 to preheat the fresh layer of powder.

At step S706, the printing sled 350 is returned across the build area 190 to the dosing blade side of the work surface. During this return stroke, as the printing sled 350 moves across the build area 190, the printheads 370 print absorber in accordance with image data onto the layer of powder deposited in the build area 190. At the same time, the sinter source 360, which is mounted immediately behind the printheads 370 in the direction of travel at step S706, sinters the newly printed powder.

The sleds 300, 350 are now in sleds position 2.

The printing sled 350 is next operated again at step S707 to return the printing sled 350 to the side of the build area opposite that of the dosing blade. Optionally, the sinter source 360 on the printing sled 350 may be switched on during step S707 to allow a second exposure of the printed powder to the sinter source to allow more energy to be imparted to the printed powder, which may help of the printed powder to reach a higher temperature.

A process for printing and sintering utilising the sled layout as illustrated in FIG. 6D, will be described, with reference to FIG. 8.

The sleds 300, 350 start at sleds position 2 at step S601, with both the powder distribution sled 300 and the printing sled 350 on the dosing blade side of the build area 190. The buffer layers have been deposited, and a first build layer of powder has been deposited as the final layer in the buffer layer process.

At step S602 the printing sled 350 is operated. The printing sled 350 moves across the build area 190 from the dosing blade side of the work surface to the opposite end of the work surface, the printing sled forward stroke. As the printing sled 350 moves across the build area 190, the printheads 370 print absorber in accordance with image data onto the layer of powder deposited in the build area 190.

At the same time, the sinter source 360, which is mounted immediately behind the printheads 370 in the direction of travel at step S602, sinters the printed area. The printing sled 350 reaches the opposite end of the work surface. Once the printing sled 350 is clear of the dosing blade 160 during step S602, or after the printing sled 350 has arrived at the opposite end of the work surface, at step S603, the dosing blade 160 is rotated, and a fresh pile of powder is brought up to the work surface level 170 along the full length of the dosing blade ready for distribution.

Next, at step S604, the powder distribution sled 300 is operated. The powder distribution sled 300 moves across the build area from the dosing blade side of the work surface to the opposite side of the work surface, the powder distribution sled forward stroke. The powder distribution sled 300 passes over the dosing blade and the roller 320 pushes the pile of powder across the build area 190, depositing a layer of powder in the build area 190, before pushing the excess powder down the return slot 210. In the arrangement of FIG. 6D, the preheat source 320 of the powder distribution sled 300 precedes the roller 320 and may optionally be used as a sinter source at step S604 so as to expose the printed powder to a sinter source for a second time during the powder distribution sled forward stroke.

The layouts of FIG. 6A to FIG. 6D is advantageous, since they enables to accurately control the time elapsed between the layer of powder being sintered by the printing sled 350 and the new layer of powder being deposited on top of the sintered layer by the powder distribution sled 300. Since the printing sled 350 and the powder distribution sled 300 are independently operable, the time elapsed between sintering and deposition step can be altered, dependent on the printing conditions, such as the environmental conditions, the temperature of the sintered layer required for a specific polymer material, the time required for different part sizes etc, since, large areas of sintered material will take longer to cool. In contrast, when the sinter source 360 and roller 320 are provided on the same sled, the time between sintering and deposition cannot be alter.

Furthermore, the new layer of powder is ideally deposited whilst the previous layer is still slightly molten following sintering. The time between sintering and the deposition of the new layer of powder is critical to the adhesion between layers and consequently the mechanical strength of a final printed part.

By initiating the dosing blade 160, once the printing sled 350 is clear of the dosing blade 160, before the printing sled 350 has arrived at the opposite end of the work surface, the fresh powder can be deposited on the newly sintered layer, before substantial cooling has occurred, resulting in an enhanced bond between the sintered powder and the fresh powder can be enhanced.

At step S605, the build chamber floor 205 is lowered by the thickness of a layer of the build, this might be in the region of 0.1 mm.

At step S606, the powder distribution sled 300 is returned across the build area 190 to the dosing blade side of the work surface, the powder distribution sled return stroke. The preheat source 310 may optionally be switched on during the return stroke of the powder distribution sled to preheat the fresh layer of powder.

Finally, at step S607, the printing sled 350 is returned to the dosing blade side of the work surface, the printing sled forward stroke. Optionally, the sinter source 360 may be used as an additional preheating source to help maintain the surface of the build area at a predetermined temperature. The intensity and/or the wavelength of radiation emitted by the sinter source 360 may be adjustable to carry out this function. Optionally, absorber may be printed on this return stroke of the printing sled 350, as the printing sled 350 moves across the build area 190. This would allow two layers of absorber to be printed on each layer of powder, which is advantageous when there are defective nozzles of the printhead or the printhead uniformity requires to be balanced between prints. The nozzles of the printhead may be shifted in a transverse direction from the printing direction and another layer of absorber printed to avoid dislocations through a finished part.

It will be understood that the above described methods are not dependent of the presence of a return slot.

The roller described as an example spreader device of the deposition sled may be a counter rotating roller.

For all of the printing and sintering processes described, it may be of benefit to lower the build area, from a deposition height, before the roller is returned back to the dosing blade side. This would prevent the powder being compacted on the return stroke. The build area may then be raised again to the deposition height before the printing sled passes over to print and sinter the powder. The build area may be lowered by several 0.1 mm, for example by 0.2 mm or 0.4 mm, and be moved back up to the deposition height, or by a slightly smaller amount, returning the build area to a height just short of the deposition height. In this way, the height may be set ready for the next powder deposition step, for example by choosing a height for which the build area is lower by a layer thickness compared to the work surface. Such a process may prevent the powder being compacted by the return movement of the powder distribution sled.

Alternatively to the floor being moved, the powder distribution sled or the roller within the powder distribution sled may be mounted such that it can be slightly raised when passing over a layer of freshly deposited powder.

As mentioned previously, the time between sintering and deposition of the new layer of powder is critical to the adhesion between layers, and consequently the mechanical strength of a final printed part. As also mentioned previously, a thermal feedback may be provided from a temperature sensor 530 such as an IR camera measuring the temperature of the build area 190. Such a sensor 530 may be used to monitor the temperature of the build area between sintering and deposition steps, for example. This may be particularly advantageous in defining when to initiate the next powder deposition step after a sintering step, for example when to initiate step S604 after step S602 of FIG. 8. This is important since some polymers such as elastomers may be more viscous after sintering than others, for example nylons, and require a lower temperature at which the next deposition step can occur, while still being at a sufficiently high temperature to allow the next powder layer to adhere well. Whilst it may be possible to define an average fixed time interval to elapse for a given powder material and process, and initiate the deposition step at the expiry of the fixed time interval from the completion of the sintering step, the optimal time elapsed to reach a defined temperature may vary as a result of, for example, the amount of absorber printed per layer, or a change in the ambient temperature. It would therefore be beneficial to monitor the actual temperature of the sintered layer and initiate the deposition as soon as a target temperature is reached.

A controller 550 to control an example deposition and printing sequence will now be described. The controller 550 may be a computing device, a microprocessor, an application-specific integrated circuit, or any other suitable device to control the functions of the various components of the printer.

The controller 550 is in communication with a data store 510 supplying print data relating to slices defining the three dimensional object to be constructed, and, for example, information on the number and thickness of build layers to be deposited for each buffer layer and object layer step.

The controller 550 may execute instructions received from the data store 510 to move the print sled from a print sled position 2 (on the dosing side of the build area) to the opposite side of the build area, and then cause the dosing blade to rotate to deposit a pile of powder on the work surface. Next, the controller 550 may execute, after expiry of a predefined time interval, further instructions to operate the powder deposition sled 300 to follow the print sled 350 and push the pile of powder over the build area and push the excess powder into the return slot. At the same time, the controller 550 may optionally execute instructions to switch on the radiation source mounted on the deposition sled 300 to preheat the layer of powder as it is being deposited. Next, the controller 550 may execute instructions to return first the deposition sled 300 and the print sled 350 to print sled position 2.

The controller 550 may receive instructions from the data store 510 to repeat this sequence to deposit a number of buffer layers before a build, for example.

The controller 550 may further receive instructions to move the print sled from sled position 2 across the freshly deposited powder layer to instruct the printheads to print a pattern based on data received from the data store with respect to the specific build layer onto the powder layer. The image data may define a cross section of the three-dimensional object to be manufactured, such as a product part definition contained in slices of a CAD model. In addition, the controller 550 may receive instructions to control the sinter lamp mounted behind the printheads on the print sled so as to sinter the powder. Instructions may include set points for e.g. radiation wavelength and/or intensity of the lamp that the controller may use to cause the lamp to switch on at a certain wavelength and/or intensity for a certain time period.

In parallel, the controller 550 may receive instructions to move the powder deposition sled across the newly sintered layer, either upon expiry of a predefined time interval or upon receiving an additional trigger signal from the temperature sensor 530, for example. The temperature of the build bed being monitored by the sensor 530 may be continuously provided to the controller 550, and upon a predetermined trigger temperature provided to the controller 550 based on the specific powder material being used, the controller 550 may initiate the deposition sled 300 to move across the newly sintered layer.

This feedback control from the temperature sensor 530 to the controller 550 allows per layer control of the optimal layer temperature at which a new powder layer should be deposited over a newly sintered layer.

The controller 550 may control further advantageous steps, for example the controller 550 may receive instructions to cause the build floor to be lowered before the deposition sled is returned to sled position 2 of Step S606, for example. The controller 550 may also control a subsequent raising of the build floor to a print and sinter height in readiness for the print and sinter step S602. Such a height may be slightly below that of the earlier height, for example lower by a thickness of the powder layer that is to be deposited next, so that the build floor need not be lowered again before the next powder deposition step, eg Step S604.

The controller 550 may execute instructions received from the data store 510 to determine whether an additional powder layer is to be formed as part of the formation of the 3D object. In response to a determination that an additional layer is to be formed, the controller 550 receives instructions to continue with further deposition, print and sinter sequences as described.

Accordingly, the present disclosure also provides a computer program or set of instruction code comprising instructions which, when executed by such a controller 550, cause the apparatus 1 to execute a method as described herein, for manufacturing a three-dimensional object from a powder.

Further provided is a computer-readable medium comprising instructions which, when executed by such a controller 550, cause the apparatus 1 to execute a method as described herein, for manufacturing a three-dimensional object from a powder.

With any of the above described sled layout options, a printhead cleaning station may be provided. The printhead cleaning station may be located at the opposite end of the work table to the dosing blade. Once the printing sled 350 has reached the end of the stroke, the printheads 370 may be cleaned before the next stroke. The printheads 370 may be cleaned after every stroke, every set number of strokes or in response to a printhead nozzle monitoring system.

For any of the above described distribution sleds, the device pushing the powder across the build area is not limited to a roller but could take the form of other known spreader devices, for example a blade mounted to the distribution sled in such a way as to leave a predetermined gap of e.g. the thickness of a powder layer between the blade edge and the build area.

It will be clear to one skilled in the art that many improvements and modifications can be made to the foregoing exemplary embodiments without departing from the scope of the present techniques.

A method for manufacturing a three-dimensional object from a powder is described herein.

According to one embodiment, the method further comprises detecting a temperature of a surface of the build area during sintering and initiating the deposition of the another layer of the powder as a result of the detected temperature.

According to another embodiment, the deposition of another layer of powder is initiated while the sintering of the layer of powder is being completed.

According to another embodiment, wherein the first radiation source is provided on the print sled.

According to another embodiment, the method further comprises pre-heating the another layer of powder, by moving a second radiation source, provided on the distribution sled, in the first direction across the build area.

According to another embodiment, wherein the second radiation source follows a distribution device provided on the distribution sled, for depositing the another layer of powder, when the distribution sled is moving in the first direction across the build area.

According to another embodiment, the method further comprises moving the distribution sled, in a second direction, opposite to the first direction back across the build area.

According to another embodiment, the method further comprises pre-heating the another layer of powder, when moving the second radiation source, provided on the distribution sled, in the second direction back across the build area.

According to another embodiment, the method further comprises moving the printing sled, in the second direction, opposite to the first direction back across the build area.

According to another embodiment, the method further comprises adjusting an intensity and/or a wavelength of the first radiation source to a pre-heat intensity and/or a pre-heat wavelength; and pre-heating the another layer of powder, when moving the first radiation source, provided on the print sled, in the second direction back across the build area.

According to another embodiment, the method further comprises adjusting an alignment of the printhead; and printing the absorber onto the another layer of powder, when moving the printhead in the second direction back across the build area.

According to another embodiment, the method further comprises sintering the layer of powder where the absorber has been printed, prior to depositing the another layer of the powder in the build area, by moving a second radiation source, provided on the distribution sled, in the first direction across the build area.

According to another embodiment, wherein the second radiation source leads the distribution device provided on the distribution sled, for depositing the another layer of powder, when the distribution sled is moving in the first direction across the build area.

According to another embodiment, the method further comprises moving the distribution sled, in a second direction, opposite to the first direction back across the build area.

According to another embodiment, the method further comprises pre-heating the another layer of powder, when moving the second radiation source, provided on the distribution sled, in the second direction back across the build area.

According to another embodiment, the method further comprises adjusting an intensity and/or a wavelength of the second radiation source to a pre-heat intensity and/or a pre-heat wavelength when the distribution sled is moving in the second direction back across the build area.

According to another embodiment, the method further comprises moving the print sled, in the second direction back across the build area.

According to another embodiment, the method further comprises adjusting the intensity and/or the wavelength of the first radiation source to the pre-heat intensity and/or the wavelength; and pre-heating the another layer of powder, when moving the first radiation source, provided on the print sled, in the second direction back across the build area.

According to another embodiment, the method further comprises adjusting the alignment of the printhead; and printing the absorber onto the another layer of powder, when moving the printhead in the second direction back across the build area.

According to another embodiment, the first radiation source follows the printhead on the print sled, when the print sled is moving in the first direction across the build area.

According to another embodiment, the method further comprises adjusting a time between moving the first radiation source in the first direction to sinter the layer of powder, and moving the distribution sled in the first direction to deposit the another layer of the powder, based on a material of the powder.

According to another embodiment, the method further comprises detecting a temperature of the surface of the build area during sintering and initiating the deposition of the another layer of powder as a result of the detected temperature.

According to another embodiment, the deposition of the another layer of powder is initiated while the sintering of the layer of powder is being completed.

According to another embodiment, wherein the first radiation source is provided on the print sled.

According to another embodiment, the method further comprises pre-heating the another layer of powder, by moving a second radiation source, provided on the distribution sled, in the second direction across the build area.

According to another embodiment, the second radiation source follows a distribution device provided on the distribution sled, for depositing the another layer of powder, when the distribution sled is moving in the second direction across the build area.

According to another embodiment, the method further comprises moving the distribution sled, in the first direction back across the build area.

According to another embodiment, the method further comprises pre-heating the another layer of powder, by moving the second radiation source, provided on the distribution sled, in the first direction back across the build area.

According to another embodiment, the method further comprises sintering the layer of powder where the absorber has been printed, prior to depositing the another layer of powder in the build area, by moving the second radiation source, provided on the distribution sled, in the second direction across the build area.

According to another embodiment, the second radiation source leads a distribution device provided on the distribution sled, for depositing the another layer of powder, when the distribution sled is moving in the second direction across the build area.

According to another embodiment, the method further comprises moving the distribution sled, in the first direction, back across the build area.

According to another embodiment, the method further comprises adjusting an intensity and/or a wavelength of the second radiation source to a pre-heat intensity and/or the wavelength when the distribution sled is moving in the first direction back across the build area; and pre-heating the another layer of powder, when moving the second radiation source, provided on the distribution sled, in the first direction back across the build area.

According to another embodiment, the method further comprises adjusting a time between moving the first radiation source in the second direction to sinter the layer of powder, and moving the distribution sled in the second direction to deposit the another layer of powder, based on a material of the powder.

According to another embodiment, the print sled and the distribution sled are provided on the same rails.

According to another embodiment, the first radiation source and/or the second radiation source comprises an infrared source.

1-40. (canceled)

41. A method for manufacturing a three-dimensional object from a powder, the method comprising:
printing an absorber onto a layer of powder deposited in a build area, by moving a print sled provided with a printhead in a first direction across the build area;
sintering the layer of powder where the absorber has been printed, by moving a first radiation source in the first direction across the build area; and
depositing a further layer of the powder in the build area, by moving a distribution sled in the first direction across the build area, the distribution sled being independently moveable from the print sled.

42. The method of claim 41, further comprising:
detecting a temperature of a surface of the build area during sintering and initiating the deposition of the further layer of the powder as a result of the detected temperature.

43. The method of claim 41, wherein the deposition of the further layer of powder is initiated while the sintering of the layer of powder is being completed.

44. The method of claim 41, further comprising:
pre-heating the further layer of powder by moving a second radiation source in the first direction across the build area, wherein the second radiation source is provided on the distribution sled.

45. The method of claim 44, wherein the second radiation source follows a distribution device provided on the distribution sled, wherein the distribution device deposits the further layer of powder when the distribution sled is moving in the first direction across the build area.

46. The method of claim 41, further comprising:
pre-heating the further layer of powder, when moving a second radiation source in a second direction opposite to the first direction back across the build area by moving the distribution sled, wherein the second radiation source is provided on the distribution sled.

47. The method of claim 41, wherein the first radiation source is provided on the print sled, further comprising:
moving the print sled in a second direction, opposite to the first direction back across the build area;
adjusting an intensity and/or a wavelength of the first radiation source to a pre-heat intensity and/or a pre-heat wavelength; and
pre-heating the further layer of powder when moving the first radiation source by moving the print sled in the second direction.

48. The method of claim 41, further comprising:
printing the absorber onto the further layer of powder, when moving the printhead in the second direction back across the build area.

49. The method of claim 41, further comprising,
prior to depositing the further layer of the powder in the build area: sintering the layer of powder where the absorber has been printed by moving a second radiation source provided on the distribution sled, in the first direction across the build area.

50. The method of claim 49, wherein the second radiation source leads a distribution device provided on the distribution sled, wherein the distribution device deposits the further layer of powder when the distribution sled is moving in the first direction across the build area.

51. The method of claim 49, further comprising:
moving the distribution sled in a second direction, opposite to the first direction back across the build area, wherein the distribution sled comprises a second radiation source, and
pre-heating the further layer of powder when moving the second radiation source in the second direction.

52. The method of claim 51, further comprising:
adjusting an intensity and/or a wavelength of the second radiation source to a pre-heat intensity and/or a pre-heat wavelength when the distribution sled is moving in the second direction back across the build area.

53. The method of claim 49, further comprising:
moving the print sled in a second direction back across the build area;
adjusting the intensity and/or wavelength of the first radiation source to the pre-heat intensity and/or the pre-heat wavelength; and
pre-heating the further layer of powder, when moving the first radiation source, provided on the print sled, in the second direction.

54. The method of claim 53, further comprising:
printing the absorber onto the further layer of powder, when moving the printhead in the second direction back across the build area.

55. The method of claim 41, further comprising: controlling time elapsed between the layer of powder being sintered by the print sled and the further layer being deposited by the distribution sled.

56. A method for manufacturing a three-dimensional object from a powder, the method comprising:
printing an absorber onto a layer of powder deposited in a build area, by moving a printhead, provided on a print sled, in a first direction across the build area;
sintering the layer of powder where the absorber has been printed, by moving a first radiation source in a second direction, opposite to the first direction back across the build area; and
depositing a further layer of the powder in the build area, by moving a distribution sled in the second direction across the build area, the distribution sled being independently operable from the print sled.

57. The method of claim 56, further comprising:
detecting a temperature of the surface of the build area during sintering and initiating the deposition of the further layer of powder as a result of the detected temperature.

58. The method of claim 56, wherein the deposition of the further layer of powder is initiated while the sintering of the layer of powder is being completed.

59. The method of claim 56, further comprising:
pre-heating the further layer of powder, by moving a second radiation source, provided on the distribution sled, in the second direction across the build area.

60. The method of claim 59, wherein the second radiation source follows a distribution device provided on the distribution sled, wherein the distribution device deposits the further layer of powder when the distribution sled is moving in the second direction across the build area.

61. The method of claim 56, further comprising:
moving the distribution sled, in the first direction back across the build area, wherein the distribution sled comprises a second radiation source, and
pre-heating the further layer of powder when moving the second radiation source in the first direction.

62. The method of claim 56, further comprising:
sintering the layer of powder where the absorber has been printed, prior to depositing the further layer of powder in the build area, by moving a second radiation source, provided on the distribution sled, in the second direction across the build area.

63. The method of claim 62, wherein the second radiation source leads a distribution device provided on the distribution sled, wherein the distribution device deposits the further layer of powder, when the distribution sled is moving in the second direction across the build area.

64. The method of claim 62, further comprising:
moving the distribution sled in a first direction, back across the build area;
adjusting an intensity and/or a wavelength of the second radiation source to a pre-heat intensity and/or the wavelength; and
pre-heating the further layer of powder, when moving the second radiation source, provided on the distribution sled, in the first direction.

65. The method of claim 56, further comprising: controlling time elapsed between the layer of powder being sintered by the print sled and the further layer being deposited by the distribution sled.

66. The method of claim 56, further comprising: sintering the layer of powder where the absorber has been printed, by moving the first radiation source in the first direction;
wherein the print sled comprises the first radiation source.

67. A controller for apparatus for manufacturing a three-dimensional object from a powder, the controller configured to receive instructions from a data store to:
control a print sled to move across a build area covered in a layer of powder;
control one or more printheads to print an absorber onto the layer of powder while the print sled moves across the build area;
control a radiation source to irradiate the layer of powder following printing of the absorber so as to sinter the layer of powder where the absorber has been printed; and
control a distribution sled comprising a distribution device to move across the build area independently from the print sled to deposit a new layer of powder over the build area, wherein the distribution sled movement is initiated in response to temperature data from a sensor sensing a temperature of the sintered layer.
